(19) United States
(12) Patent Application Publication
(10) Pub. No.: US 2006/0238163 A1
(43) Pub. Date: Oct. 26, 2006

(54) Mobile phone having solar cell

(75) Inventor: Ga-Lane Chen, Fremont, CA (US)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/408,432

(22) Filed: Apr. 21, 2006

(30) Foreign Application Priority Data
Apr. 22, 2005 (CN) 200510034355.3

(51) Int. Cl. H02J 7/00

(52) U.S. Cl. 320/114

(57) ABSTRACT

A mobile phone includes a main body. The main body further includes a solar power module, a display module, and an input module (i.e., a keypad). The solar power module is adapted for providing electrical power to the mobile phone. The solar power module includes a solar cell panel configured for converting light energy to electrical power. The input module includes a control switch for setting the solar power module in one of the following states: “on”, “off”, or “storage”. Advantageously, the mobile phone can also be supplied with at least one heating pad disposed on the surface thereof, selectively controlled (e.g., on/off and/or a temperature chosen), to provide heat to a hand and/or other body part of a user.

### BACKGROUND

1. Technical Field

The invention relates generally to mobile phones and, more particularly, to a mobile phone having a solar cell, which can convert sunlight into electrical energy for use by the unit.

2. Discussion of Related Art

As electronic technology develops, portable personal appliances like mobile phones, laptops and mini cassette players are commonly used. A conventional mobile phone generally includes a phone body and a battery. The battery can supply electrical energy to the phone body for usage. However, the intensity of the electrical energy supplied from the battery is limited. The traditional mobile phone will stop working at all as the electrical energy runs out. Therefore, rechargeable batteries are suggested broadly for mobile phones. The rechargeable batteries can be charged many times by a charger using an alternating current power source. In the meantime, conventional rechargeable batteries for the mobile phones have been pursued through the development of nickel-cadmium (Ni—Cd) batteries, nickel-hydrogen (Ni—H) batteries, lithium-ion (Li-ion) batteries, etc. The rechargeable batteries can perform a charge-discharge behavior thousands of times.

In general, a kind of mobile phone can only use a particular kind of rechargeable battery and do so only with a matched charger. That is, as the mobile phone running out, the rechargeable battery can't be charged without the corresponding charger. Moreover, the charger of the rechargeable battery is often not small enough to be taken with oneself. Therefore, people frequently fall into a situation where batteries of their devices are discharged and can't be charged in time. This problem has called for a new kind of mobile phones that doesn't need a particular charger and can satisfy the uninterrupted, long-time usage.

In addition, some countries, such as Russia, Canada, and many northern European countries are very cold in the winter. The cold exterior environment can limit the usage of a mobile phone. Therefore, it has also called for a new mobile phone that can advantageously generate heat though an energy conversion to warm up the user's hand or body.

What is needed, therefore, is a new mobile phone that has a solar cell, which is capable of converting the sunlight energy to electric power for the mobile phone, and, further advantageously, for the new mobile phone to be able generate heat to warm up the user in a cold exterior environment.

### SUMMARY

A mobile phone includes a main body. The main body further includes a solar power module, at least one of a display module and an audio communication unit, and a power-state input module. The solar power module is configured for providing electrical power to the mobile phone. The solar power module includes a solar cell panel exposed to an external environment and thus adapted for converting sunlight energy to electrical power. The power-state input module includes a control switch configured for selectably placing the solar power module in one of the states of “on”, “off”, and “storage”.

Other advantages and novel features of the present mobile phone will become more apparent from the following detailed description of preferred embodiments, when taken in conjunction with the accompanying drawings.

### BRIEF DESCRIPTION OF THE DRAWINGS

Many aspects of the present mobile phone can be better understood with reference to the following drawings. The components in the drawings are not necessarily to scale, the emphasis instead being placed upon clearly illustrating the principles of the present mobile phone.

FIG. 1 is a front, schematic view of a mobile phone having a solar cell, in accordance with one embodiment of the present device; and

FIG. 2 is a back, schematic view of the mobile phone of FIG. 1.

Corresponding reference characters indicate corresponding parts throughout the several views. The exemplifications set out herein illustrate at least one preferred embodiment of the present mobile phone, in one form, and such exemplifications are not to be construed as limiting the scope of the invention in any manner.

### DETAILED DESCRIPTION OF PREFERRED EMBODIMENTS

Reference will now be made to the drawings to describe embodiments of the present mobile phone, in detail.

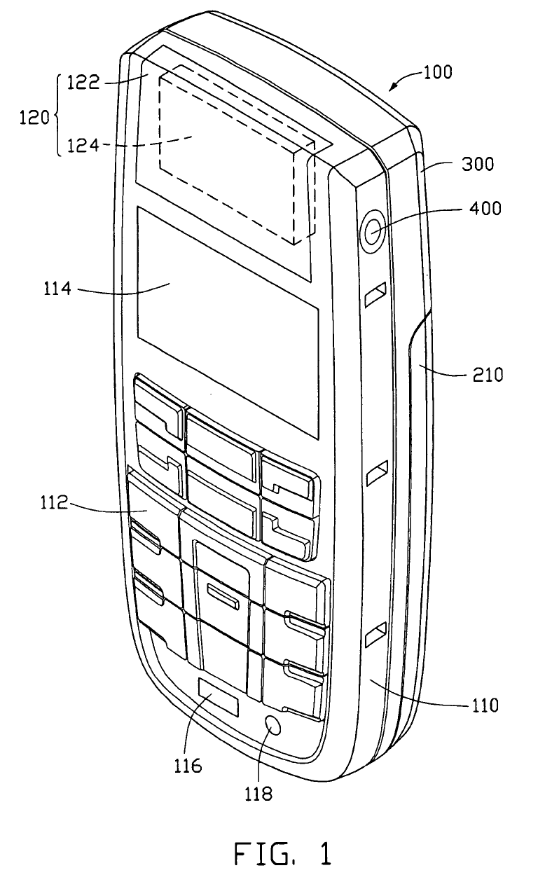

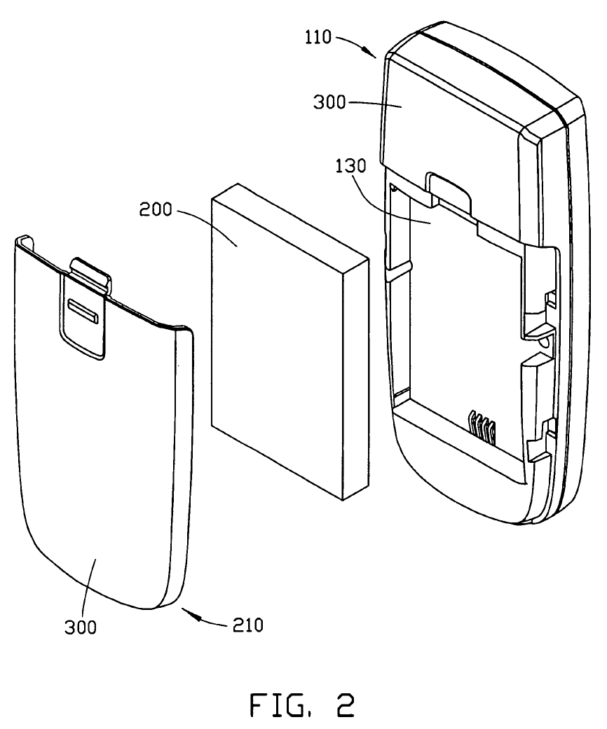

Referring to FIGS. 1 and 2, a mobile phone 100, in accordance with one embodiment of the present device, is provided. The mobile phone 100 includes a main body 110, a battery 200, a battery cover 210, and at least one heating pad 300. The main body 110 has an opening 130 (i.e., a battery opening) located within (i.e., extending into) a back surface thereof. The battery 200 is disposed in the battery opening 130 of the main body 110 and is covered by the battery cover 210. The heating pads 300 are disposed on a back surface of the mobile phone 100. The battery 200 can be a lithium-ion battery, a lithium polymer battery, or another rechargeable battery. Each heating pad 300 can be, e.g., a number of heating lines mixed into a cotton cloth or another fabric (woven or non-woven).

The main body 110 further incorporates a keypad 112, a display screen 114, a solar power unit 120, a printed circuit board (not shown), and a radio frequency module (not shown). The keypad 112 (i.e., the input module) is disposed generally on the bottom/lower half or portion of a front surface of the main body 110. Such a keypad 112 is adapted for inputting selected signals (e.g., dialing, data entry, etc.). The keypad 112 further has a control switch 116 and a heating switch 118. The control switch 116 and the heating switch 118 can, for example, be pressable switches. The control switch 116 is used for controlling the solar power unit 120. The heating switch 118 is used for controlling the heating pads 300. By pressing the control switch 116 and heating switch 118, respectively, the solar power unit 120 can be selectively placed in one of an “on”, “off” or “storage” state, and the heating pads 300 can be turned “on” or “off”. The display screen 114 is disposed on the middle of the front surface of the main body 110. The solar power unit 120 further includes a solar cell panel 122 and a storage unit 124. The solar cell panel 122 is, in the embodiment shown, disposed on the top of the front surface of the main body 110 and, when exposed to an external environment, is configured for absorbing sunlight or other ambient light and converting the light into electrical energy The solar cell panel 122 can be fabricated of any one of various solar-conversion (i.e., photoelectric) materials, such as amorphous silicon or a known nano-scale photoelectric material. The storage unit 124 (e.g., in the form of a capacitor or a rechargeable battery) is disposed in the interior of the main body 110 and is structured and arranged for storing the electrical energy generated by the solar cell panel 122. Such electrical energy is thereby available for usage by the mobile phone 100. The printed circuit board and the radio frequency module are also disposed in the inner of the main body 110. The keypad 112, the display screen 114, the solar power unit 120, and the radio frequency module are electrically connected to the printed circuit board. The display screen 114 is adapted for displaying information related to the operation of the mobile phone 100. The radio frequency module is configured for transmitting and receiving radio signals. When light reaches the solar cell panel 122, based on the photoelectric properties of the semiconductor thereof, the solar cell panel 122 can convert light energy (e.g., sun or ambient) into electrical energy. The electricity generated by the solar cell panel 122 may be supplied from the solar cell panel 122 to the main body 110 for use thereof by the mobile phone 100.

In accordance with the present mobile phone 100, the solar power unit 120 can be controlled by the control switch 116 so as to selectively be in the state of “on”, “off”, or “storage”. When the solar power unit 120 is in the state of “off”, the solar power unit 120 is not working/enabled. In the meantime, the mobile phone 100 is working like a conventional mobile phone, in that the main body 110 can be supplied with electrical energy by the battery 200. When the solar power unit 120 is in the state of “on”, the solar power unit 120 is working. The solar cell panel 122 can absorb the light when the solar cell panel 122 is exposed to direct rays of light. The solar cell panel 122 can convert the light into electrical energy and, in the “on” state, supply the electrical energy to the main body 110 directly. When the solar power unit 120 is in the “storage” state, the storage unit 124 of the solar power unit 120 is enabled. In this state, the electrical energy generated by the solar cell panel 122 can be stored in the storage unit 124 for later usage. It is to be understood that the electrical energy needed for operation of the mobile phone 100 could be supplied by the solar power unit 120 and/or the battery 200, working separately or in tandem. It is to be further understood that the present mobile phone 100 could particularly advantageously be designed to recognize a need for tandem operation (e.g., low battery; low lighting) to maximize current available power and to automatically attempt to function in such a dual-power source state.

In accordance with the present mobile phone 100, the heating pads 300 can be set by the heating switch 114 to either an “on” state or “off” state. When the heating pads 300 are in the “on” state, the heating pads 300 are operational. The battery 200 and/or the solar power unit 120 can supply electrical energy to the heating pads 300. Thus, the heating pads 300 can generate heat to warm up the user's hands and/or another body part (e.g., ear). When the heating pads 300 are turned “off”, the heating pads 300 stop generating heat.

In addition, the mobile phone 100, in accordance with the present device, can be integrated with further any of a variety of functions including, for example, a digital camera, MP3 player, video player, and/or data storage unit. In the illustrated embodiment, a digital camera (not shown in its entirety) is disposed in the inner of the main body 110 with a camera lens 400 disposed within an outside surface of the main body 110. A MP3 player (not shown) is disposed in the inner of the main body 110, thereby providing the present device the ability to play music. In addition, the mobile phone 100 can potentially perform the function of receiving e-mail and/or other computer functions.

As is known to those skilled in the art, the heating pads 300 of the present mobile phone 100 can be disposed on other surface portions of the main body 110 (in addition or alternatively to the back thereof), such as the bottom surface of the main body 110. Moreover, the control switch 116 and the heating switch 118 can be knob switches for controlling the operational states of the solar power unit 120 and the heating pads 300. Furthermore, the position for the battery 200 can be rearranged within the present mobile phone 100, as can, likewise, many other units associated therewith, within particular critical design limitations associated with such features (e.g., display and camera opening need to be on opposite sides of the main body to be practical). It is to be further understood that another solar cell panel, either in addition to the solar cell panel 120 or alternatively thereto, could be positioned on the back side of the mobile phone 100, thus allowing light to reach the solar cell panel, even when a phone call is being made. When the mobile phone 100 includes the battery 200 and the solar power unit 120 simultaneously, the mobile phone 100 can be supplied with electrical energy by either of the battery 200 or the solar power unit 120. When the mobile phone 100 only includes the solar power unit 120, the mobile phone 100 can, obviously, only be supplied with electrical energy by the solar power unit 120.

Compared with conventional mobile phones, the mobile phone 100 of the described embodiments has the following advantages. Firstly, the present mobile phone 100 can convert light energy to electrical energy by the solar power unit 120. The solar power unit 120 can be easily controlled by the control switch 116, either in the state of “on”, “off” or “storage”. When the battery 200 of the mobile phone 100 is out of power and the user is in a place where the electrical energy is cannot be obtained (e.g., no source and/or no charger available), a photoelectric conversion of light to electrical energy can be performed by the solar power unit 120 of the mobile phone 100, thus permitting the continued usage thereof. Secondly, the mobile phone 100 can generate heat by the heating pads 300 disposed thereon. The heating pads 300 can be easily controlled, via the heating switch 118, so as to be “on” or “off”. The heat generated though the energy conversion can warm up the user's hand and/or another body. It is to be further understood the heating switch 118 could be in the form of a thermostat, allowing a range of temperatures to be chosen, as well as an “off” state.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

We claim:

1. A mobile phone comprising:
a main body;
a solar power module supported by the main body, the solar power module being configured for providing electrical power to the mobile phone, the solar power module comprising at least one solar cell panel, each solar cell panel being a photoelectric element adapted for converting light energy to electrical power;
a display module carried by the main body; and
an input module operatively associated with the main body, the input module being comprised of a keypad, the input module including a control switch configured for selectably setting the solar power module in one of an “on”, “off”, and “storage” state.

2. The mobile phone as claimed in claim 1, wherein the mobile phone further comprises at least one heating pad disposed on the surface of the mobile phone.

3. The mobile phone as claimed in claim 2, wherein the input module further comprises a heating switch configured for placing each heating pad in one of an “on” state and an “off” state.

4. The mobile phone as claimed in claim 2, wherein at least one such heating pad comprises a number of heating lines mixed into a fabric.

5. The mobile phone as claimed in claim 1, wherein the solar power module further comprises a storage unit disposed in the interior of the main body, the storage unit being configured for storing the electrical power generated by the solar cell panel.

6. The mobile phone as claimed in claim 1, wherein the main body further comprises an opening, the opening extending into a back surface of the main body.

7. The mobile phone as claimed in claim 6, further comprising a battery disposed in the opening of the main body.

8. The mobile phone as claimed in claim 7, wherein the mobile phone further includes a battery cover adapted for engaging with the back of the main body in a manner so as to cover the opening receiving the battery, at least one heating pad being disposed on a back surface of the battery cover.

9. The mobile phone as claimed in claim 1, wherein the input module is disposed on a lower portion of a front surface of the main body.

10. The mobile phone as claimed in claim 1, wherein the display module is disposed in the middle area of the front surface of the main body.

11. The mobile phone as claimed in claim 1, wherein at least one such solar cell panel is disposed on the top of the front surface of the main body.

12. A mobile phone comprising:
a main body;
a display module carried by the main body;
an input module operatively associated with the main body, the input module being comprised of a keypad, the input module including at least one control switch; and
at least one of the following modules:
a solar power module supported by the main body, the solar power module being configured for providing electrical power to the mobile phone, the solar power module comprising at least one solar cell panel, each solar cell panel being a photoelectric element adapted for converting light energy to electrical power, the input module including a solar power control switch configured for selectably setting the solar power module in one of an “on”, “off”, and “storage” state; and
a heating module including at least one heating pad and a heating switch, each heating pad being disposed on the surface of the mobile phone, the heating switch being configured for selectively controlling the heating of the at least one heating pad.
